(19) United States
(12) Patent Application Publication
(10) Pub. No.: US 2020/0191627 A1
(43) Pub. Date: Jun. 18, 2020

(54) MEASURING DEVICE FOR DETERMINING A FLUID VARIABLE

(71) Applicant: DIEHL METERING GMBH

(72) Inventors: PETER PLOSS, Bayreuth (DE); Thomas Sturm, Sachsen (DE); Michael Mayle, Ansbach (DE); Andreas Benkert, Ansbach (DE)

(21) Appl. No.: 16/674,469

(22) Filed: Nov. 5, 2019

(30) Foreign Application Priority Data
Dec. 12, 2018 (DE) 10 2018 009 753.

(51) Int. Cl. G01F 1/66; B06B 1/02; G01P 5/24

(52) U.S. Cl. CPC G01F 1/667; B06B 1/0261; G01N 2291/02836; G01P 5/245; G01F 1/662

(57) ABSTRACT

A measuring device determines a fluid variable with a control device, a measuring tube and a first vibration transducer arranged at the measuring tube. The first vibration transducer contains a vibration element. The vibration element has a vibration body, a first electrode on the measuring tube side and a second electrode averted from the measuring tube. The first electrode extends over a first end face of the vibration body. The second electrode extends to a second end face that lies opposite the first end face. A respective conductive contact element contacts the first electrode at a first end face and the second electrode at a second end face electrically and mechanically such that the vibration element is supported by the contact elements. A voltage between the first and second electrodes can be varied through the vibration element to excite a guided wave in a side wall of the measuring tube.

### CROSS-REFERENCE TO RELATED APPLICATION

This application claims the priority, under 35 U.S.C. § 119, of German application DE 10 2018 009 753.7, filed December 12, 2018; the prior application is herewith incorporated by reference in its entirety.

### BACKGROUND OF THE INVENTION

### Field of the Invention

The invention relates to a measuring device for determining a fluid variable relating to a fluid and/or a fluid flow of the fluid, with a control device, a measuring tube that serves to accommodate and/or guide the fluid, and a first vibration transducer arranged at the measuring tube, wherein the first vibration transducer contains at least one vibration element.

Ultrasonic counters are one possible way of detecting a flow rate or another measured variable relating to a fluid. These use at least one ultrasonic transducer in order to couple an ultrasonic wave into the fluid flowing through the measuring tube, wherein this is guided to a second ultrasonic transducer on a direct path or after a plurality of reflections at walls or special reflection elements. A speed of the flow through the measuring tube can be determined from the transit time of the ultrasonic wave between the ultrasonic transducers, or from a transit time difference when the transmitter and receiver are exchanged.

The use of so-called interdigital transducers to excite guided waves, wherein a piezoelectric element having comb-like, intermeshing control lines is used to achieve an excitement of specific excitation modes of guided waves is known from the article by G. Lindner, “Sensors and Actuators Based on Surface Acoustic Waves Propagating along Solid-Liquid Interfaces” J. Phys. D: Appl. Phys. 41 (2008) 123002. Since shear modes of the piezoelectric element are necessarily excited, the excitation typically does not achieve high efficiencies. A relatively complex, highly precise lithography is, furthermore, necessary in order to apply the required electrode structure exactly enough, while sufficient modal purity of the excitation is, nevertheless, often not achieved.

Excitation of a modally pure guided wave is nevertheless highly relevant for use in an ultrasonic counter, since the angle at which compression vibrations are radiated into the fluid depends on the phase velocity of the guided wave which typically is different in different excitation modes at the same excited frequency. If different modes are excited, different propagation paths result for the compression vibrations in the fluid which can, at best, be computationally removed through a complex signal evaluation.

### SUMMARY OF THE INVENTION

The invention is therefore based on the object of providing a measuring device that uses guided waves for measurement, wherein a low space requirement and a simple construction of the measuring device used should be realized.

The object is achieved according to the invention by a measuring device of the type mentioned at the beginning, wherein the vibration element contains a vibration body, an electrode on the measuring tube side that is arranged on a side face of the respective vibration body on the side of the measuring tube, and an electrode averted from the measuring tube that is arranged at a side face of the vibration body averted from the measuring tube on the opposite side to the side face on the measuring tube side. The electrode on the measuring tube side extends over a first end face of the vibration body that is angled with respect to the side face on the measuring tube side and the side face averted from the measuring tube. The electrode averted from the measuring tube extends to a second end face that lies opposite the first end face. A respective conductive contact element contacts the electrode on the measuring tube side at the first end face and the electrode averted from the measuring tube at the second end face electrically and mechanically in such a way that the vibration element is supported by the contact elements. Through this electric contacting by means of the control device a voltage between the electrode on the measuring tube side and the electrode averted from the measuring tube can be varied in order through the vibration element to excite, in a side wall of the measuring tube, a guided wave that can be guided directly via the side wall or indirectly via the fluid to a second vibration transducer arranged at the measuring tube or back to the first vibration transducer, and which can be detected there by the control device for the determination of measured data. The fluid variable can be determined by the control device depending on this measured data.

It was established in the course of developing the invention that modally pure guided waves can also be excited in particular cases by vibration elements lying substantially flat against the side wall of the measuring tube that comprise electrodes on opposite sides. This can, for example, be achieved in that through a suitable choice of the dimensions of the vibration element, a natural mode of the vibration element can be matched to a wavelength of the desired excited vibration, or that a plurality of vibration elements are used, whereby, with suitable drive, unwanted vibration modes can substantially be entirely eliminated through a destructive interference. It is, however, necessary here that the natural vibrations of the vibration elements are disturbed as little as possible, or that the vibration elements are attached to the measuring tube with a defined geometry. Vibration elements, i.e. for example piezocrystals, are usually glued or soldered into the desired position with respect to the measuring tube. As a result, however, natural vibrations of vibration elements can be disturbed in a manner that is difficult to predict, and it is relatively complex to manufacture vibration transducers with multiple vibration elements with sufficient precision. In addition, the usual types of fastening can lead to tensions as a result of different thermal expansions, and an additional working step is necessary in order to contact the vibration elements.

Through the combination of the electrodes drawn over both end faces, and supporting the vibration elements at these end faces by means of conductive contact elements as provided by the invention, the mechanical fastening of the vibration element and its contacting are achieved in a single working step. In addition, the positioning of the vibration element with respect, for example, to a housing at which the contact elements are provided, is achieved in a simple working step with high precision. Since a cohesive bond is not used, tensions resulting from different thermal expansions of components and similar problems are, furthermore, avoided. Since support is provided, moreover, through forces perpendicular to the direction of vibration, the proposed support results on the one hand in a significantly lower coupling of vibrations into a housing or other components of the measuring device that supports the vibration element or the vibration elements, and the natural vibrations of the vibration elements are, on the other hand, significantly less affected than is the case with usual methods of fastening.

The contact elements can be configured as one piece and, for example, consist of an appropriately cut or stamped metal sheet. The first and second end faces are preferably parallel to one another or are positioned at an angle of less than 10°, preferably at an angle of less than 5° to one another. A particularly robust support by the contact elements can be achieved through this. The vibration body can be rectangular. In particular it can have an elongated rectangular shape. The support is preferably achieved through end faces that lie opposite one another in terms of the longitudinal direction of such a rectangular vibration body. The vibration body can consist of a piezoelectric material, in particular of a piezoceramic.

The measured data can be captured in various ways in order to determine different fluid variables. In order, for example, to realize the flow rate measurement referred to at the beginning, a guided wave can be excited in the side wall, the wave being suitable to excite compression vibrations in the fluid, for example a Lamb wave. The compression wave is coupled into the fluid directly or after at least one further reflection at a side wall, and can be detected there by the second vibration transducer. On the other hand, a transit time of the guided wave within the side wall can, for example, be measured, in that a Rayleigh wave in which substantially only the outer side of the side wall of the measuring tube vibrates, a Lamb wave which due to the speed of sound in the fluid cannot be coupled into the fluid, or similar can be excited, wherein the wave is substantially exclusively transported by the side wall. This can, for example, serve to measure a pressure of the fluid, since such a pressure can deform or stress the side wall and thus influence the sound velocities in the side wall. A transit time of the wave to the second vibration transducer or along a certain propagation path back to the first vibration transducer can be captured here.

A large number of further approaches for determining fluid variables of a fluid or a fluid flow with the aid of waves guided through the fluid, ultrasonic waves in particular, are known in the prior art. Through an appropriate configuration or programming of the measuring device according to the invention it is possible to adjust which measured data are recorded and which fluid variables determined.

The vibration element is preferably supported by the contact elements with friction locking. Substantially plane contact sections of the contact elements preferably lie at the corresponding electrodes against the corresponding end faces with a compression force generated by the elasticity of the contact elements. It would also be possible as an alternative for the vibration elements to be mounted with positive lock through appropriately formed electrodes and/or contact sections. Cohesive bonding should preferably be avoided. The vibration element is, in particular, preferably neither glued nor soldered to the contact elements.

At least one of the contact elements can be elastically deformed by the mechanical contact with the vibration element. The elasticity of the contact element can be chosen such that substantially no deformation of the vibration element, or only a very slight one, results from the applied clamping force.

At least one of the contact elements can be or comprises a plate that extends substantially parallel to the end face contacted by the contact element, wherein the plate is bent elastically through the contact with the vibration element. A very simple construction of the measuring device with, at the same time, robust support of the vibration element is achieved by this. Due to the elastic bending of the plate, the angle between the plate and the end face is not constant, but however is preferably less than 10°, in particular less than 5° over the full length of the plate.

The first vibration transducer can comprise a plurality of the vibration elements which are vibrationally coupled directly or via a coupling element to a respective excitation region of the side wall. The control device is configured to drive the vibration elements in such a way that in each of the excitation regions a partial wave guided in the side wall is excited. The partial waves overlay to form the guided wave. A vibration mode that is to be attenuated is at least partially eliminated through a destructive interference of the partial waves. Preferably precisely two vibration elements are used, since in this way typically a sufficiently modally pure excitation is possible. Additional vibration elements can, however, be used to further increase the modal purity.

It is a challenge for a modally pure excitation of a guided vibration that in the case, for example, of an excitation of Lamb waves, at least two different vibration modes can be excited at each excitation frequency which, as explained at the beginning, have different phase velocities in the side wall of the measuring tube. Through an appropriate choice of the excitation frequency it is possible to arrange that only precisely two vibration modes, namely an anti-symmetric and a symmetric vibration mode are excited. A modally selective, or substantially modally pure, excitation can now be achieved in that the vibration mode of these vibration modes that is unwanted, i.e. the vibration mode that is to be attenuated, can be at least partially eliminated through a destructive interference of the partial waves. If both vibration elements are operated at the same excitation frequency, then the relative phase of a vibration of a first vibration transducer and a vibration mode excited by a second vibration transducer that enters the excitation region of the first vibration transducer depends on the distance between the vibration elements and thus the excitation regions of the vibration elements, and on the wavelength of the corresponding mode, which, due to the different phase velocities, differs for the two modes. A relative phase relation of the vibrations of the vibration elements can thus be selected such that at a given spacing a destructive interference results for the vibration mode that is to be attenuated. Two possibilities for this are explained in more detail below.

One technically particularly simple possibility for achieving a destructive interference is to choose the excitation frequency and the spacing of the vibration elements in such a way that the distance between the centers of the excitation regions corresponds to half of the wavelength of the vibration mode that is to be attenuated. If the vibration elements now vibrate with the same polarity, a destructive interference results for the vibration mode that is to be attenuated. It would also be possible as an alternative to choose the distance such that it corresponds to the wavelength of the vibration mode that is to be attenuated, and to operate the vibration elements with inverse polarity, for example in that an excitation signal used for both vibration elements is inverted for one of the vibration elements, or in that one of the vibration elements is mounted with inverted polarity. The excitation frequency can particularly preferably be chosen such that precisely one long-wave and precisely one short-wave vibration mode can be excited, wherein the long-wave vibration mode has twice the wavelength of the short-wave vibration mode. This has the result that, using the procedure explained above, not only does a destructive interference result for the vibration mode that is to be attenuated, but in addition an optimum constructive interference for the remaining vibration mode, with which a particularly high signal-to-noise ratio can be achieved in the excitation. If, in addition, the distance between the centers of the excitation regions is chosen such that it corresponds to the wavelength of the short-wave vibration mode, then it is possible to choose which of the modes should be excited in a substantially modally pure manner by switching over the excitation polarity of one of the vibration elements.

The procedure explained already leads to a very high modal purity, while if the same envelope curve is used for the excitation pulses at both vibration elements, an optimum destructive interference is typically not achieved at the beginning and end of the excitation pulse. It is therefore advantageous if the first and the second vibration transducers are driven to excite the guided wave in such a way that the temporal curve of the vibration amplitude of the second vibration element corresponds to the temporal curve of the vibration amplitude of the first vibration element delayed by a delay period. Preferably the delay period corresponds to the transit time of the vibration mode that is to be attenuated from the first vibration element to the second vibration element. One possibility for this is to use a common drive signal for the first and second vibration element, wherein the signal fed to the second vibration element is delayed by the delay period by means of a delay unit which can, for example, be provided in the control device. If the second vibration element is now operated with inverted polarity, for example in that the control signal is additionally inverted, a substantially complete destructive interference results for the mode that is to be attenuated, and thus an excitation with a high level of modal purity. In addition, the use of such a delay unit is also advantageous, since if there is a change to the wavelength of the vibration mode that is to be attenuated, for example because a different mode should be attenuated or because the excitation frequency changes, only the delay period has to be changed.

Precisely one of the electrodes of precisely one of the vibration elements can be electrically and mechanically contacted by at least one of the contact elements. In this way it is possible for the vibration elements to be driven in different ways by the control device. A drive with inverted and/or delayed excitation signals can, for example, be provided in order to achieve a modally selective excitation and, in particular, a modally selective excitation for a selectable mode.

It is also possible that at least one common contact element electrically and mechanically contacts a respective electrode of at least two of the vibration elements. It is possible here that only one such common contact element is used, for example in order to provide a reference potential for a respective one of the electrodes, while in contrast the respective vibration element is subjected to a control voltage by the control device. It is nevertheless also possible that both respective electrodes are contacted by a respective common contact element. This enables a particularly simple construction of the measuring device.

The common contact element can comprise two separate, in particular plate-like, contact sections that are exclusively connected by an in particular plate-shaped connecting section that is arranged separately from the vibration elements. The contact sections can, in particular, be exclusively mechanically supported by the connecting section. Preferably the contact sections and the connecting section are implemented in one piece, for example being cut, stamped or formed together in a similar way from one metal sheet. The common contact element can, for example, have the shape of a Y or of a tuning fork.

The vibration transducer can comprise a housing in which the vibration elements are supported by the contact elements. The housing can, on the one hand, serve to support the vibration elements in a defined position with respect to one another. On the other hand it can protect the vibration elements against environmental influences. The housing can, for example, together with the measuring tube, surround the vibration elements on all sides, and thus be protectively sealed against dust and water splash, or even be watertight or gastight.

The manufacture and/or servicing of the measuring device can be simplified if the vibration transducer is present as a sealed unit, i.e. the vibration elements are encapsulated even before the attachment of the vibration transducer to the measuring tube. This is, for example, possible in that the housing is sealed by a vibration membrane or vibration plate, as explained below.

The coupling element can be a vibration membrane or a vibration plate which extends over and beyond the excitation regions of the vibration elements of the first vibration transducer. If a housing is provided, this vibration membrane or vibration plate can be fastened to the housing, for example welded to it or fixed in a similar manner. The vibration membrane can, for example, be a foil. The use of such a vibration membrane or vibration plate is, however, also possible in principle without an additional housing, that is with exposed vibration elements.

The vibration transducer can comprise a housing that contains a housing wall that extends over and beyond the side faces of the vibration elements that are averted from the measuring tube, wherein the contact elements extend through the housing wall. This is, in particular, advantageous if the vibration elements, as explained above, should be protected against environmental influences. The vibration elements can be encapsulated in the housing, wherein a simple contacting via the contact elements that are brought through the housing wall is nevertheless possible.

At least one of the contact elements can consist of a metal sheet or of a conductive elastomer which is in particular sprayed onto the housing of the vibration transducer. A contact element consisting of metal sheet can, for example, be cut or stamped from a metal sheet, and thus manufactured very easily. Spraying a conductive elastomer onto a housing also permits an easy manufacture of the measuring device. The elastomer can here additionally be located in at least one part of the region between the side of the vibration element averted from the measuring tube and the housing, in order to provide further support to the vibration element. In order to avoid short-circuiting the contact elements by way of the electrode averted from the measuring tube and/or heavily influencing the vibration behaviour of the vibration element here, it is advantageous if, as explained below, electrodes are used at the vibration element that are drawn over the respective opposing side of the vibration body.

In the measuring device according to the invention, either the electrode on the measuring tube side can be arranged exclusively at the side face that faces the measuring tube and precisely one of the end faces, and the electrode averted from the measuring tube exclusively at the side face averted from the measuring tube and precisely one other of the end faces, or the electrodes on the measuring tube side and averted from the measuring tube can be arranged at the respective end face and the side face that faces the measuring tube and the side face averted from the measuring tube. An at least approximately symmetrical structure of the electrodes is thus proposed, whereby a disturbance of the natural vibrations of the vibration elements due to an asymmetric influence of the mechanical properties or a presence of asymmetric fields can be avoided.

In the case in which the electrodes each extend both over the side face on the measuring tube side and the side face averted from the measuring tube, regions in which the same electrode is present both in the measuring tube side as well as averted from the measuring tube result, in particular in edge regions that are adjacent to the end faces. Thus even when a voltage is applied between the two electrodes, only very small fields result in the vibration body in the edge regions, and these edge regions also thus vibrate with very low amplitude when the vibration element is excited into vibration. A coupling of vibration between the vibration element and the contact elements is hereby further reduced, and the influence of the contacting on the natural modes of the vibration element on the one hand, and the coupling of vibrations by way of the contact elements into the housing on the other hand, can thus be reduced. In addition it is possible to arrange that the same electrode is always present adjacent to the end faces at the side of the vibration element averted from the measuring tube as at the end face, whereby, as explained above, contact elements that support the vibration element at the side face averted from the measuring tube in addition to contacting at the end face can also be used.

Other features which are considered as characteristic for the invention are set forth in the appended claims.

Although the invention is illustrated and described herein as embodied in a measuring device for determining a fluid variable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1 and 2 are diagrammatic, sectional views of an exemplary embodiment of a measuring device according to the invention; and

FIGS. 3 and 4 are sectional views of further exemplary embodiments of a measuring device according to the invention.

### DETAILED DESCRIPTION OF THE INVENTION

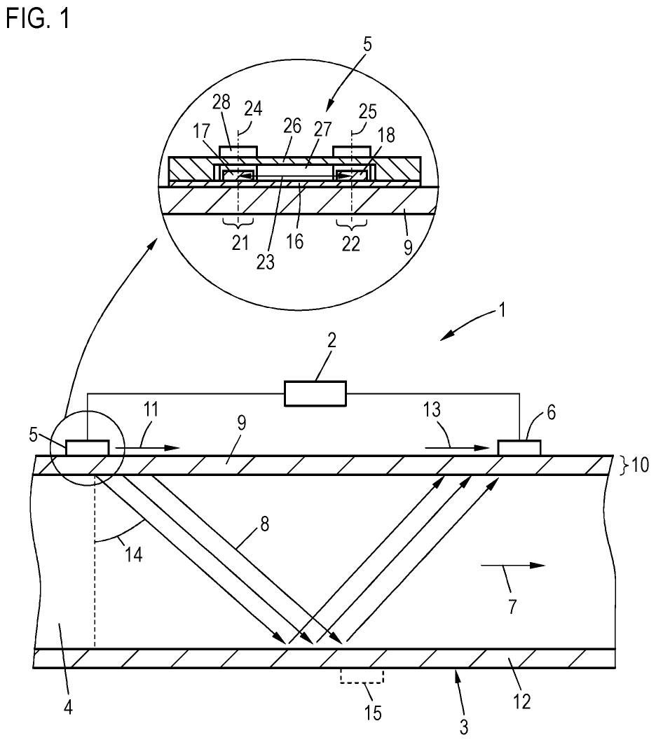

Referring now to the figures of the drawings in detail and first, particularly to FIG. 1 thereof, there is shown a measuring device 1 for determining a fluid variable related to a fluid and/or a fluid flow. The fluid is guided here in a direction shown by the arrow 7 through an interior space 4 of a measuring tube 3. In order to determine the fluid variable, in particular a volume flow rate, a transit time difference between the transit times from a first vibration transducer 5 to a second vibration transducer 6 and vice versa can be determined by a control device 2. Use is made here of the fact that this transit time depends on a velocity component of the fluid parallel to a direction of propagation through the fluid of an ultrasonic beam 8. A fluid velocity in the direction of the respective ultrasonic beam 8 averaged over the path of the respective ultrasonic beam 8 can thus be determined from this transit time and thereby, approximately, an averaged flow velocity in the volume crossed by the ultrasonic beam 8.

In order on the one hand to enable an arrangement of the vibration transducers 5, 6 outside the measuring tube 3 and, on the other hand, to reduce sensitivity in respect of different flow velocities at different positions of the flow profile, the first vibration transducer 5 does not directly introduce an ultrasonic beam 8, i.e. a pressure wave, into the fluid. A guided wave is instead excited in a side wall 9 of the measuring tube 3 by the vibration transducer 5. The excitation takes place at a frequency that is selected such that a Lamb wave is excited in the side wall 9. Such waves can be excited if a thickness 10 of the side wall 9 is comparable to the wavelength of the transverse wave in the solid body, which is given from the ratio of the sound velocity and the transverse wave in the solid body to the excited frequency.

The guided wave excited in the side wall 9 by the vibration transducer 5 is shown schematically by the arrow 11. Compression vibrations of the fluid, which are radiated into the fluid in the entire propagation path of the guided wave, are excited by the guided wave. This is illustrated schematically by the ultrasonic beams 8, offset with respect to one another in the flow direction. The radiated ultrasonic beams 8 are reflected at opposite side wall 12 and guided through the fluid back to the side wall 9. The incoming ultrasonic beams 8 there again excite a guided wave in the side wall 9, illustrated schematically by arrow 13, which can be detected by the vibration transducer 6 in order to determine the transit time. Alternatively or in addition it is possible for the radiated ultrasonic waves to be detected by a vibration transducer 15 that is arranged at the side wall 12. In the illustrated example, the ultrasonic beams 8 are either not reflected or only reflected once at the side walls 9, 12 on their path to the vibration transducer 6, 15. It would, of course, be possible, to use a longer measurement segment in which the ultrasonic beams 8 are reflected multiple times at the side walls 9, 12.

It can be problematic in the procedure outlined that the dispersion relationship for Lamb waves in the side wall 9 has a plurality of branches. With excitation at a certain frequency determined by the control device 2, it would thus be possible for different vibration modes for the Lamb wave having different phase velocities to be excited. This has the result that the compression waves are radiated at different Rayleigh angles 14 depending on these phase velocities. From this, different paths, typically having different transit times, result for the guidance of the ultrasonic wave from the vibration transducer 5 to the vibration transducer 6 and vice versa. The received signals for these different propagation paths must thus be separated through a complex signal processing by the control device 2 in order to be able to determine the fluid variable. This requires, on the one hand, a complex control device and it cannot on the other hand be robust in all applications. The guided waves should therefore be excited with the greatest possible modal purity in the vibration transducer 5.

In order to achieve an excitation of a total guided wave in the side wall 9 that is largely modally pure, the vibration transducer 5 that contains a plurality of spaced vibration elements 17, 18 arranged in spaced excitation regions 21, 22 is used. The arrangement should be done in such a way that a center 24, 25 of the excitation regions 21, 22 have a defined spacing 23 which, as will be explained later in yet more detail, is important for the modally pure excitation. In order to enable an accurate positioning and the contacting of the vibration elements 17, 18 at the same time with low effort, these are not arranged individually at the side wall 9, but are supported by the respective contact elements 28, 29, as is shown in detail in FIG. 2, in a recess 27 of a housing 26, so that the housing 26 with the vibration elements 17, 18 held to it by the contact elements 28, 29, can subsequently be arranged on the side wall 9 as a module.

As is illustrated in FIG. 1, it can be advantageous here to use in addition a coupling element 16, for example a thin foil or a vibration plate, which is arranged between the vibration elements 17, 18 and the respective excitation regions 21, 22 of the side wall 9. By mounting such a coupling element 16 on the housing 26, the vibration transducer 5 is provided as a compact module. This, on the one hand, makes the handling of the vibration elements 17, 18 easier in the context of the assembly of the measuring device 1, and on the other hand serves to encapsulate the vibration elements 17, 18 against environmental influences.

As shown in detail in FIG. 2, the vibration elements 17, 18 each consist of a vibration body 30, an electrode 31 on the measuring tube side, and an electrode 32 averted from the measuring tube. The electrode 31 on the measuring tube side here is arranged on a side face 33 that faces the measuring tube, and extends as far as the first end face 34 at which it is electrically contacted by the contact element 28. The electrode 32 that faces the measuring tube correspondingly extends on the one hand over the side face 35 averted from the measuring tube and on the other hand as far as the second end face 36, where it is electrically contacted by the contact element 29. The contact elements 28, 29 are fastened to the housing 26, and together clamp the respective contact element 17, 18, so that these are each mechanically supported.

The contact elements 28, 29 are each manufactured from metal sheet, for example cut or stamped, and have a certain elasticity, so that when the respective vibration element 17, 18 is inserted between the respective contact elements 28, 29 they are elastically deformed, and thus apply a certain compression force to the vibration element 17, 18, and thus support it with friction locking. The vibration elements 17, 18 are here each contacted by separate contact elements 28, 29. This makes it possible to provide different control signals, or control signals of different polarity, to the vibration elements 17, 18, whereby, for example, a modally selective excitation of different vibration modes depending on the drive by the control device 2 is made possible. The end 37 of the contact elements 28, 29 that does not lie on the vibration element 17, 18 is in each case brought through a housing wall 38 of the housing 26 that borders the recess 27 at the side averted from the measuring tube. A simple contacting of the vibration elements 17, 18, from the rear side of the housing is thus made possible, wherein at the same time the vibration elements 17, 18 can be encapsulated in the housing in order to protect them from environmental influences and to improve their handleability.

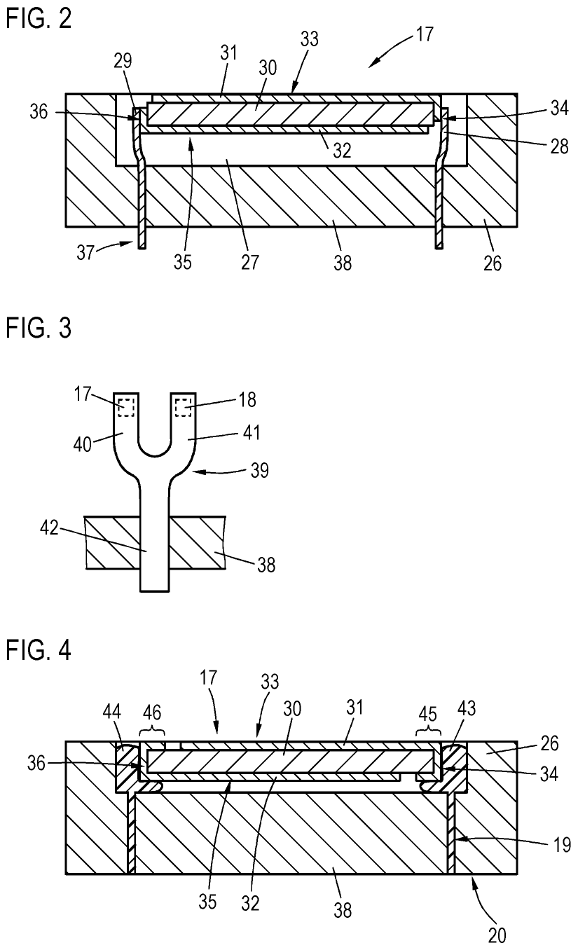

It is not required in all applications that it must be possible for different signals to be supplied to the electrodes 31 on the measuring tube side and the electrodes 32 averted from the measuring tube of the two vibration elements 17, 18. It can, for example, be possible that both electrodes 31 on the measuring tube side, or both electrodes 32 that are averted from the measuring tube, or one of these electrodes in each case, should be placed at a specific reference potential, and it should only be possible for the electrode of the vibration elements 17, 18 remaining in each case to be separately driven. In this case the structure of the measuring device 1 can be further simplified, for example in that the common contact element 39 shown in FIG. 3 is used instead of the contact element 28 or 29. This comprises two separate, plate-shaped contact sections 40, 41, each of which serves to contact or to support the vibration elements 17, 18 only suggested schematically in FIG. 3. The two contact sections 40, 41 are exclusively joined by a plate-shaped connecting section 42 in that the contact element 39 can be fastened to the housing 26 or which can serve to bring the contact element 39 through the housing wall 38 in order to enable contacting on the rear side.

Through the Y-like structure shown in FIG. 3 it is possible for the two vibration elements 17, 18, to be contacted with very little effort, while at the same time a vibration coupling between the vibration elements 17, 18 is largely avoided through the use of separate contact sections 40, 41. The contact element 39 can, for example, be made of metal sheet, for example stamped or cut from a metal sheet.

FIG. 4 shows a further possibility for configuring contact elements 43, 44 which on the one hand contact the electrodes 31, 32 at the end faces 34, 36 and, on the other hand, clamp the vibration elements 17, 18 by means of the mechanical force applied in this way and thus support them in a fixed position. In the exemplary embodiment shown in FIG. 4 the contact elements 43, 44 are formed of a conductive polymer that is, for example, foamed or sprayed onto the housing 26. The contact elements 43, 44 are dimensioned here in such a way that they are pushed together in the transverse direction in FIG. 4 when the respective vibration element 17, 18 is inserted, as a result of which they exert a clamping force on the end faces 34, 36 after the insertion of the vibration elements 17, 18, and thus support the vibration elements 17, 18 with friction locking. In the exemplary embodiment shown, the housing 26 also has openings 19 that are also filled with the conductive polymer, so that in this exemplary embodiment too the contact elements 43, 44 are brought through the housing wall 38 to the rear side 20 of the housing 26, where they can be contacted without difficulty by way of the rear side 20 even after the application of the housing 26 and thereby of the vibration elements 17, 18 to the measuring tube 3.

Even with the use of a conductive polymer it would, in principle, as explained above, be possible for the contact elements 43, 44 to mechanically and electrically contact the vibration elements 17, 18 exclusively at the end faces 34, 36. It can, however, be advantageous if the contact elements 43, 44 additionally support the vibration element 17, 18 at the side face 35 that faces away from the measuring tube, as illustrated in FIG. 4.

In order in addition here to improve the contacting of the electrode 31 on the measuring tube side, it is drawn in the edge region 45 as far as the side face 35 of the vibration body 30 that faces away from the measuring tube. Since an asymmetric arrangement of the electrodes 31, 32 can lead to anti-symmetric vibration modes, which can potentially conflict with a modally pure excitation of guided waves, the electrode 32 averted from the measuring tube is in addition drawn in the edge region 46 up to the side face 33 of the vibration body 30 that faces the measuring tube. This sort of arrangement of the electrodes 31, 32 can also be advantageous, since in the edge regions 45, 46, due to the same respective electrode 31, 32 being arranged on both side faces 33, 35, even when voltage is applied to the vibration elements 17, 18, only very low field strengths result, and thus the vibration amplitudes in the edge regions 45, 46 are also small. This on the one hand removes stress from the mechanical contacts that serve to support the vibration elements 17, 18, and on the other hand reduces the coupling of vibration into the housing 26. A disturbance of the natural modes of the vibration elements 17, 18 resulting from a coupling with the housing can also be reduced by such a procedure. It can therefore also be advantageous to use such an electrode arrangement when the electrodes 31, 32 are exclusively contacted by way of the end faces 36, 37, as was explained above in relation to FIGS. 2 and 3.

### LIST OF REFERENCE SIGNS

1 Measurement device
2 Control device
3 Measurement tube
4 Interior
5 First vibration transducer
6 Second vibration transducer
7 Arrow
8 Ultrasonic beam
9 Side wall
10 Thickness
11 Arrow
12 Side wall
13 Arrow
14 Angle
15 Vibration transducer
16 Coupling element
17 Vibration element
18 Vibration element
19 Opening
20 Rear face
21 Excitation region
22 Excitation region
23 Distance
24 Centre
25 Centre
26 Housing
27 Recess
28 Conductive contact element
29 Conductive contact element
30 Vibration body
31 Electrode on the measuring tube side
32 Electrode averted from the measuring tube
33 Side face on the measuring tube
34 First end face
35 Side face averted from the measuring tube
36 Second end face
37 End face
38 Housing wall
39 Conductive contact element
40 Contact section
41 Contact section
42 Connecting section
43 Conductive contact element
44 Conductive contact element
45 Edge region
46 Edge region

1. A measuring device for determining a fluid variable relating to a fluid and/or a fluid flow of the fluid, the measuring device comprising:
a controller;
a measuring tube serving to accommodate and/or guide the fluid and having a side wall; and
vibration transducers including a first vibration transducer and a second vibration transducer:
said first vibration transducer disposed at said measuring tube, said first vibration transducer having at least one vibration element, said at least one vibration element having a vibration body with a first end face and a second end face, a first electrode on a measuring tube side and disposed on a first side face of said vibration body on a side of said measuring tube, and a second electrode averted from said measuring tube and is disposed at a second side face of said vibration body averted from said measuring tube on an opposite side to said first side face on said measuring tube side, wherein said first electrode on said measuring tube side extending over a first end face of said vibration body that is angled with respect to said first and second side faces on said measuring tube side and averted from said measuring tube, wherein said second electrode averted from said measuring tube extends to said second end face that lies opposite said first end face, said first vibration transducer further having contact elements contacting said first electrode on said measuring tube side at said first end face and said second electrode averted from said measuring tube at said second end face electrically and mechanically in such a way that said vibration element is supported by said contact elements, wherein through this electrical contacting by means of said controller a voltage between said first and second electrodes on said measuring tube side and averted from said measuring tube can be varied in order through said vibration element to excite, in said side wall of said measuring tube, a guided wave that can be guided directly via said side wall or indirectly via the fluid to said second vibration transducer disposed at said measuring tube or back to said first vibration transducer, and which can be detected there by said controller for a determination of measured data, wherein the fluid variable can be determined by said controller depending on the measured data.

2. The measuring device according to claim 1, wherein said vibration element is supported with friction locking by said contact elements.

3. The measuring device according to claim 1, wherein at least one of said contact elements is elastically deformed by mechanical contact with said vibration element.

4. The measuring device according to claim 1, wherein at least one of said contact elements can be or comprises a plate that extends substantially parallel to said first or second end face contacted by said one contact element, wherein said plate is bent elastically through the contact with said vibration element.

5. The measuring device according to claim 1, wherein:
said at least one vibration element of said first vibration transducer is one of a plurality of vibration elements which are vibrationally coupled directly or via a coupling element to a respective excitation region of said side wall; and
said controller is configured to drive said vibration elements in such a way that in each said respective excitation region a partial wave guided in said side wall is excited, wherein partial waves overlay to form the guided wave, wherein a vibration mode that is to be attenuated is at least partially eliminated through a destructive interference of the partial waves.

6. The measuring device according to claim 5, wherein at least one of said contact elements electrically and mechanically contacts precisely one of said first and second electrodes of precisely one of said vibration elements.

7. The measuring device according to claim 5, further comprising at least one common contact element electrically and mechanically contacting a respective one of said first and second electrodes of at least two of said vibration elements.

8. The measuring device according to claim 7, wherein said common contact element contains two separate contact sections that are exclusively connected by a plate-shaped connecting section that is disposed separately from said vibration elements.

9. The measuring device according to claim 5, wherein said coupling element is a vibration membrane or a vibration plate which extends over and beyond said excitation regions of said vibration elements of said first vibration transducer.

10. The measuring device according to claim 5, wherein:
said first vibration transducer contains a housing that has a housing wall that extends over and beyond said second side faces of said vibration elements that are averted from said measuring tube; and
said contact elements extend through said housing wall.

11. The measuring device according to claim 1, wherein at least one of said contact elements is formed of a metal plate or a conductive elastomer.

12. The measuring device according to claim 1, wherein said first electrode on said measuring tube side is disposed exclusively at said first side face that faces said measuring tube and precisely one of said first and second end faces, and said second electrode averted from said measuring tube exclusively at said second side face averted from said measuring tube and said other end face, or said first and second electrodes on said measuring tube side and averted from said measuring tube are disposed at said respective ones of said first and second end faces and said first side face that faces said measuring tube and said second side face averted from said measuring tube.

13. The measuring device according to claim 8, wherein said two separate contact sections are plate-shaped.

14. The measuring device according to claim 11, wherein said metal plate or said conductive elastomer is sprayed onto said housing of said first vibration transducer.
